(19) United States
(12) Patent Application Publication
(10) Pub. No.: US 2007/0157889 A1
(43) Pub. Date: Jul. 12, 2007

(54) Feline solarium

(76) Inventor: Hana K. Mc Donough, Blauvelt, NY (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/329,463

(22) Filed: Jan. 11, 2006

(51) Int. Cl. A01K 1/03

(52) U.S. Cl. 119/484

(57) ABSTRACT

A feline solarium or pet enclosure for mounting in a standard window preferably includes a housing having an interior space capable of accommodating a household pet or the like, where the housing is at least partially disposed outside of the window when mounted. Such a housing is also preferably constructed entirely of transparent material to provide complete viewing of the outside environment. The enclosure may further include at least two wings capable of moving with respect to the housing so as to cover spaces created between the enclosure and the window, and which dictate the size of the opening to the interior of the housing.

### BACKGROUND OF THE INVENTION

The present invention relates to enclosures for pets, and more particularly to an enclosure capable of being mounted in a window frame to be used by a household pet or the like.

For centuries, man has domesticated various animals, such as canines and felines. Where this once meant retaining these animals on spacious farms or other expanses of land, it has evolved into confining such animals to the interiors of houses, or even small apartments. Clearly, this is far from the natural habitat the wild ancestors of these animals once roamed.

Nonetheless, man has also historically created various contraptions to aid in housing or otherwise keeping such animals. For example, it has been established to retain dogs, birds, or other animals in cages. It is also well known to provide litter boxes or the like to allow felines the opportunity to remain indoors while performing natural bodily functions. In addition, it has been taught by others to provide devices for use in windows or other architectural openings, which allow for animals such as cats to experience the feeling of being outdoors and closer to their natural intended habitat.

In this latter case, it has been well established to provide enclosures that extend from windows or other architectural openings and allow entry of household pets or the like. In fact, such enclosures have been well known for many years. Typically, they include an interface for cooperating and connecting with a window or the like, and an open enclosure portion, which extends outdoors, for housing an animal. The open enclosure also typically includes one or more transparent portions that allow for viewing to the outdoor world. However, such enclosures have historically not been without their drawbacks. For example, the aforementioned viewing windows or transparent portions historically have been small in size. This is often caused by an overly complex frame needed to support the overall enclosure, and clearly takes away from the viewing experience of the animal. Additionally, the openings to the open enclosure portions have generally been fixed and not capable of being adaptable for differently sized windows, while also allowing for the varying in size of the opening to the enclosure.

Therefore there exists a need for an improved pet enclosure which not only provides for a larger viewing area, but also allows for greater adaptability for various windows and other architectural openings.

### SUMMARY OF THE INVENTION

A first embodiment of the present invention is a pet enclosure for mounting in a window. The pet enclosure of this first embodiment preferably includes a housing having an interior space and consisting entirely of transparent material. The pet enclosure also preferably includes a horizontal extension attached to the housing, the horizontal extension being capable of engaging a sill portion of the window, and a vertical extension attached to the housing, the vertical extension being capable of engaging a sash portion of the window.

In other embodiments of the first aspect of the present invention, the horizontal and vertical extensions may be formed integral with the housing. One of the horizontal extension or the vertical extension may further include a first track, with one wing being slidably engaged with the first track. The other of the horizontal extension or the vertical extension may further include a second track, with at least one wing being slidably engaged with the first and second tracks. The pet enclosure may include two wings slidably engaged with the first and second tracks. In other embodiments, the vertical extension may include at least two elongated apertures being capable of aligning with apertures of the two wings, the apertures capable of receiving fixation means for mounting to the sash portion. In addition, the horizontal extension may include at least one aperture capable of receiving fixation means for mounting to the sill portion. Access into the interior space of the housing may be determined by the position of the at least one wing. The pet enclosure of this first aspect of the present invention may further include certain accessories. For example, hooks, rods, clips may be provided within the housing so as to allow pet toys to be fastened thereto. Such toys may add further entertainment to an animal to be housed in the enclosure. In addition, pillows, benches, shelves and the like may also be provided. Finally, the housing may further include a litter box. It is also to be understood that the pet enclosure of this first aspect may also be utilized to house household plants or other vegetation.

A second embodiment of the present invention is another pet enclosure for mounting in a window. In accordance with this second embodiment, the pet enclosure may include a housing defining an interior space and having an opening to the interior space, a horizontal extension attached to the housing, the horizontal extension being capable of engaging on a sill portion of the window and including a first track, a vertical extension attached to the housing, the vertical extension being capable of engaging a sash portion of the window and including a second track, and at least two wings, each of the wings being slidably engaged with the first and second tracks so that sliding movement of the wings defines the accessible amount of the opening to the interior space.

A third embodiment of the present invention is yet another pet enclosure for mounting in a window. In accordance with this third embodiment, the pet enclosure preferably includes a housing defining an interior space and having an opening to the interior space, the housing being constructed entirely of transparent material, a horizontal extension attached to the housing, the horizontal extension being capable of engaging a sill portion of the window and including a first track, a vertical extension attached to the housing, the vertical extension being capable of engaging a sash portion of the window and including a second track and at least two wings, each of the wings being slidably engaged with the first and second tracks so that sliding movement of the wings defines the amount of the opening to the interior space which is accessible.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a perspective view of a feline solarium or pet enclosure in accordance with one embodiment of the present invention.

FIG. 2 is a side cross sectional view of the pet enclosure shown in FIG. 1, shown mounted in a window frame.

FIG. 3 is a front view of the pet enclosure shown in FIG. 1, shown mounted in a window frame.

FIG. 4 is a rear view of the pet enclosure shown in FIG. 1.

FIG. 5 is a top view of the pet enclosure shown in FIG. 1.

### DETAILED DESCRIPTION

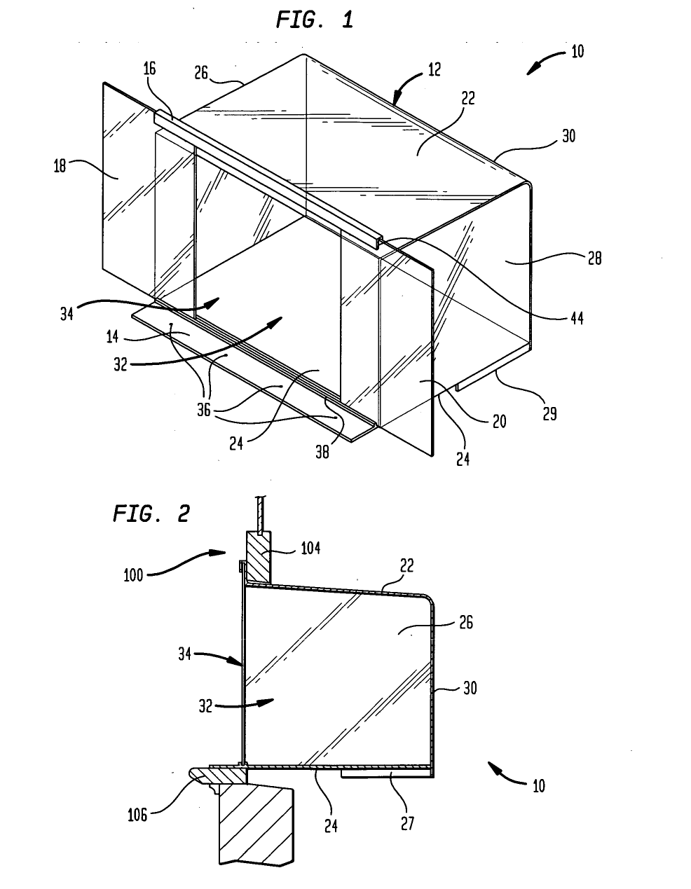

Referring to the drawings, wherein like reference numerals refer to like elements, there is shown in FIG. 1 a pet enclosure designated generally by reference numeral 10. Although shown in the drawings as being a feline solarium sized and configured to accommodate a normal sized household feline, it should be understood that the described enclosure 10 can be adapted to house many different types of animals, and to fit within many different sized and configured windows. In addition, it should also be understood that enclosure 10 may be utilized to house household plants or other vegetation. Clearly, such types of vegetation may benefit from the added sunlight most likely present within the enclosure when it is placed in a window. In this regard, one use that could be widely adopted is to utilize enclosure 10 to germinate seedlings or the like. Those of ordinary skill in the art would recognize how enclosure 10 could be modified in order to be adapted into any of the above-noted different circumstances. As can be seen in FIG. 1, enclosure 10 preferably includes a housing 12, horizontal extension 14, vertical extension 16 and wings 18 and 20. Each of these elements will be more fully discussed below, but it is to be understood that enclosure 10 may include fewer or additional elements to those shown in the figures and described herein.

Housing 12 is shown in the drawings as being substantially rectangular in shape, including a top wall 22, bottom wall 24, left and right side walls 26 and 28, and rear wall 30. This necessarily creates an enclosure having an interior space 32, which can be accessed through front opening 34. Preferably, housing 12 is formed as a unitary structure from substantially transparent materials such as clear polymeric materials. For example, Lexan®, Plexiglass®, etc. . . . may be utilized in constructing housing 12. In fact, most preferably, housing 12 should allow full view through all of its walls/surfaces from the point of view of an animal housed within interior space 32. Although housing 12 is depicted in the drawings as being substantially rectangular in shape, it is noted that housing 12 may be many different shapes and/or sizes. For example, to provide a more sleek looking enclosure 10, and one in which vision through the transition points between the different walls is clearer, housing 12 may be more curved or rounded. In addition, as mentioned above, housing 12 may be many different sizes in order to fit within different sized or configured windows and to accommodate differently sized household pets.

As is also depicted in the drawings, the aforementioned left and right side wall 26 and 28 may further include downward projecting portions 27 and 29, respectively. Such downward projecting portions 27 and 29 may also be referred to as drip edges, and may be useful in directing rain water, melting snow or condensation away from other portions and surfaces of enclosure 10. In addition, it is also noted that bottom wall 24 may further include differing bottom wall sections (not shown). In such a design, one bottom wall section may extend lower than the other bottom wall section in order to allow for a litter box or the like to be disposed therein. Such litter boxes are well known in the art, and could easily be sized and configured to fit within a deeper bottom wall section of enclosure 10. As housing 12 could further include vent/air holes through one or more of its walls, placing a litter box or the like within enclosure 10 may allow for any unpleasant odors to be vented directly to the outside environment. This is clearly advantageous over the well-known method of providing a litter box in the interior of a house or apartment. It is noted that any holes provided in any of the walls of housing 12 should be such that rain or other outside weather effect (e.g.—snow, ice, dust, etc.) cannot enter into interior space 32. For example, providing holes on either section of bottom wall 24 may prevent water or the like from entering into housing 12. In addition, any such holes may be sized and/or configured to prevent insects or other creatures from entering interior space 32. In this regard, it is contemplated to provide relatively small holes, or to provide a screen or the like to cover such holed surfaces. It is also noted that any such deeper bottom wall section could be designed so as to align with the above-discussed drip edges 27 and 29. This may provide a sleeker looking housing 12.

As is mentioned to above, housing 12 is preferably substantially transparent. Such a design therefore preferably does not include an opaque frame or the like. Many different manufacturing processes may be utilized in forming housing 12. For example, it is contemplated to mold or otherwise form housing 12 from a single piece of transparent material. In addition, it is also contemplated to form individual sections of housing 12, and thereafter fix them to one another to construct the housing. For example, housing 12 could be formed as two separate pieces, which are thereafter attached together to form the structure of housing 12. It is also noted that fixing together a plurality of pieces of housing 12 may be done in many different fashions. Such pieces could be glued, welded, or attached together utilizing additional fixation means. Of course, such fixation means could include relatively transparent screws, nails or the like, so as to further aid in attaching separate portion of housing together while keeping it transparent.

In certain embodiments, housing 12 may further include certain accessories (not shown). For example, hooks, rods, clips may be provided within the housing so as to allow pet toys to be fastened thereto. Such toys may add further entertainment to an animal to be housed in the enclosure. In addition, pillows, benches, shelves and the like may also be provided. Providing shelves, for instance, may be beneficial in the case where enclosure 10 is being utilized to house plants or other vegetation. Clearly, such a set up would allow for multiple potted plants to be situated within housing 12.

In addition to housing 12, enclosure 10 includes other elements, as briefly mentioned above. In the embodiment depicted in the figures, enclosure 10 further includes horizontal extension 14 and vertical extension 16, both of which may be integrally formed with housing 12. These elements are useful in mounting enclosure 10 to a window or other architectural opening. Horizontal extension 14 is essentially an extension from bottom wall 24 that extends in a horizontal direction from housing 12. Preferably, horizontal extension 14 is the component of enclosure 10 which may be mounted to a sill portion of a window (best shown in FIG. 2). In this regard, horizontal extension 14 preferably includes a plurality of apertures 36 capable of receiving screws, nails or other fixation means. For example, in the embodiment depicted in the figures, horizontal extension 14 includes four screw receiving apertures that allow for screws to be inserted through the extension and into a window sill. In addition, horizontal extension 14 includes a first track 38, preferably formed between extension 14 and bottom wall 24. This track 38 will be discussed more fully below.

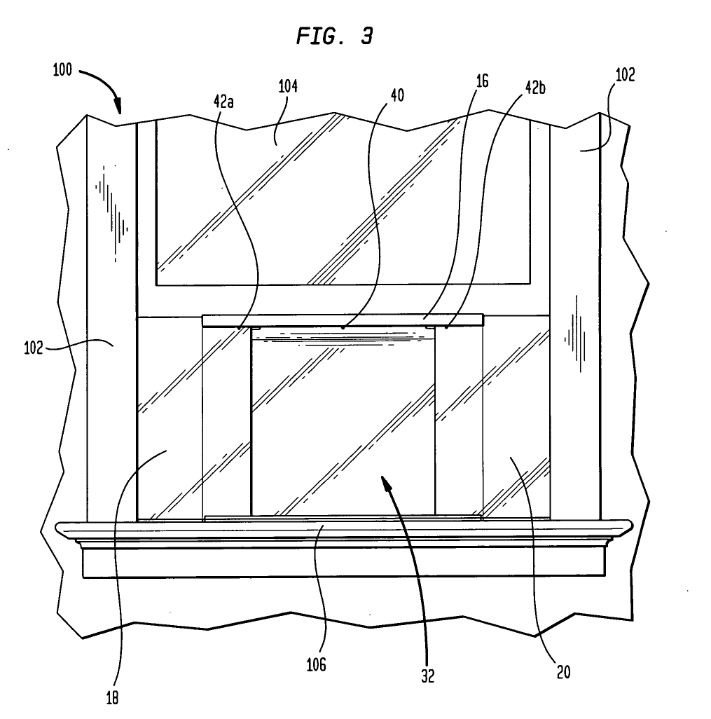

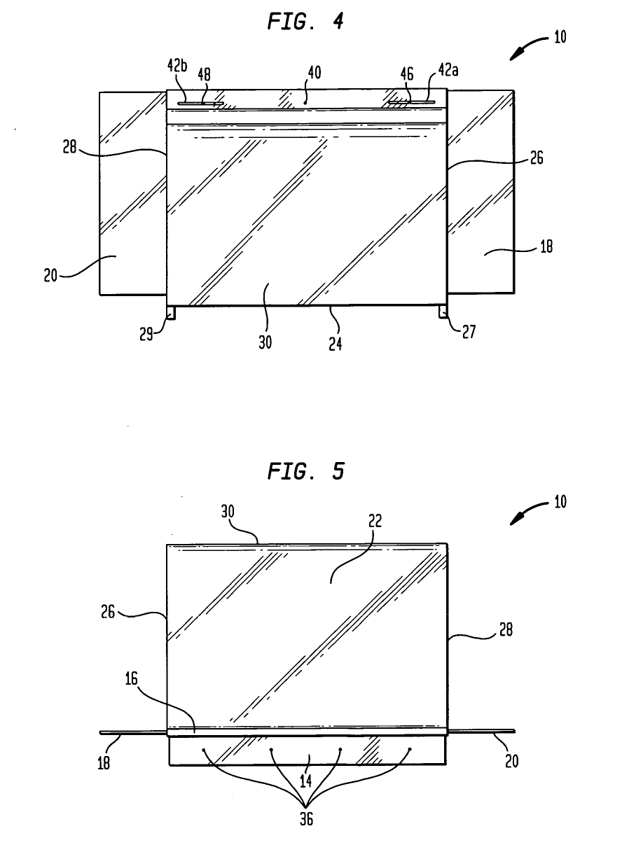

Like horizontal extension 14, vertical extension 16 is also useful in contacting a portion of a window or other architectural opening and aiding in retaining enclosure 10 therein. More particularly, horizontal extension 12 is preferably designed so as to rest against the bottom portion of a movable window sash or the like (best shown in FIG. 2) and may be affixed thereto to prevent accidental slippage or movement. Horizontal extension 14 is preferably forced against the bottom of a window sash or the like through the operation of gravity (i.e.—the weight of housing 12 extending beyond the sash). Once again, vertical extension 16 may include apertures or the like (best shown in FIGS. 3 and 4), for receiving fixation means, such as those discussed above. For example, as shown in FIGS. 3 and 4, vertical extension 16 preferably includes one middle aperture 40 flanked on either side by elongated apertures or slots 42a and 42b. The utility and operation of such apertures will be discussed more fully below in the discussion relating to the use of enclosure 10. However, it is noted that it is not necessary that both horizontal and vertical extensions 14 and 16 have such apertures. Enclosure 10 may be affixed to a window through the use of fixation means cooperating with either or both of the extensions. Finally, similar to horizontal extension 14, vertical extension 16 preferably includes a second track 44. Once again, this will be discussed more fully below.

Enclosure 10 also preferably includes wings 18 and 20 for deployment between opposite sides of a window or other architectural opening. As shown in the figures, wings 18 and 20 are each disposed within the aforementioned tracks, such that the bottom portions of the wings reside within first track 38, and the top portions of the wings reside within second track 44. Preferably, the cooperation between wings 18 and 20 and first and second tracks 38 and 44 is such that the wings may slide freely with respect to housing 12. Although not so specifically depicted in the figures, this movement may be aided by the addition of wheels, ball bearings or the like between the wings and the tracks. One of ordinary skill in the art would recognize how to modify the design shown in the figures to include such components.

In the embodiment shown in the figures, wings 18 and 20 are constructed of material similar to that utilized in constructing housing 12 (i.e.—transparent material). However, it is noted that the wings may be constructed of any material suitable for slidable cooperation with the above-described extensions. In addition, it is noted that wings 18 and 20 each preferably includes similar fixation apertures (best shown in FIG. 4 as elements 46 and 48) to those discussed above in relation to horizontal extension 14. In constructing or manufacturing enclosure 10, housing 12 is preferably formed as discussed above, along with horizontal and vertical extensions 14 and 16. Thereafter, wings 18 and 20 are preferably slid into the open ends of tracks 38 and 44. However, other methods of manufacture could clearly be employed. For example, extensions 14 and 16 could be formed separate from housing 12, and thereafter assembled to the housing.

An exemplary method of utilizing enclosure 10 will now be described. First, the user would place housing 12 through a properly sized and opened window, such as window 100 depicted in FIGS. 2 and 3. This would provide for at least part of housing 12 to protrude out from window 100 and into the environment outside of the architectural building having window 100. Typically, windows (like window 100) include at least a frame, a movable sash, and a sill portion. These elements are labeled as elements 102, 104 and 106, respectively, in FIGS. 2 and 3. As shown in those figures, sash 104 is in the open position, or spaced from sill 106 enough so that top wall 22 and bottom wall 24 of housing 12 can be fit therebetween. As the sides of frame 102 are generally fixed, housing 12 must be sized and configured to fit between them. Preferably, housing 12 should be sized so that left and right side walls 26 and 28 fit between the sides of frame 102 with spaces disposed on each of their respective sides.

Ultimately, housing 12 should be placed between each of the window 100 elements until horizontal extension 14 rests on sill 106, and then sash 104 is lowered against top wall 22 so that vertical extension 16 rests against at least the bottom of sash 104. However, it is to be understood that various window configurations are well known in the art, and as such, embodiments of enclosure 10 may be provided to cooperate with such different configurations, or the enclosure depicted in the drawings may be adapted to cooperate with same. For example, enclosure 10 could be utilized in conjunction with a window that employs a horizontal moving sash portion (as opposed to the vertical moving sash shown in the figures). In such a design, horizontal extension 14 would still preferably abut a sill portion of the window, but vertical extension 16 would abut a top portion of a frame of the window.

With housing 12 disposed within open window 100, wings 18 and 20 may be deployed to cover any spaces between the sides of frame 102 and left and right side walls 26 and 28. This now creates a seal between window 100 and enclosure 10, sealing out the outside environment. Preferably, this seal should be such that it acts in a similar fashion to that of a closed window. It is noted that poorly sealed areas between enclosure 10 and window 100 may be further sealed by utilizing well known means, such as caulk or epoxy based sealants, foam or rubber strips and the like. Utilization of such sealants may also be required with respect to the other joints not permanently affixed in enclosure 10. For example, it may be beneficial to seal the areas where wings 18 and 20 meet horizontal and vertical extensions 14 and 16.

Finally, enclosure 10 may now be fixed to window 100. As mentioned above, horizontal extension 14 preferably includes apertures 36 which may receive fixation means. Clearly, such fixation means (e.g.—screws) would be placed through such apertures and into sill 106. This would prevent most, if not all, vertical movement of enclosure 10 with respect to window 100. It is noted that enclosure 10 may be affixed to sill 106 prior to or subsequent to the deployment of wings 18 and 20. In addition, it is noted that horizontal extension 14 may include other fixation means, such as clips or the like.

Next, with wings 18 and 20 deployed, fixation means may be inserted through middle aperture 40 of vertical extension 16 and into the bottom portion of sash 104. In addition, fixation means may be inserted through elongated apertures 42a and 42b of vertical extension, through apertures 46 and 48 of wings 18 and 20 respectively, and ultimately into the bottom of sash 104. The elongated nature of apertures 42a and 42b clearly allow for apertures 46 and 48 to align therewith, given the different states of deployment of wings 18 and 20. With fixation means inserted through each of the aforementioned apertures and into sash 104, not only is most, if not all, horizontal movement of enclosure 10 with respect to window 100 prevented, but so is any movement of wings 18 and 20 with respect to housing 12. This, in connection with the fixation of horizontal extension 14, necessarily creates a substantially rigid structure ensuring a seal between enclosure 10 and window 100.

It is noted that the deployment of wings 18 and 20 also determines the amount of front opening, 34 which is accessible by a household pet, such as a feline. In other words, when enclosure 10 is mounted in a window employing a relatively narrow construction, the amount of front opening not blocked by wings 18 and 20 is less than that which would be uncovered if enclosure 10 were mounted in a window having a relatively wide construction. This means that the size of the opening for use by a pet is dictated by the size of the window in which enclosure 10 is mounted. It is also contemplated to provide a two piece wing design in which one piece of each wing can be fixedly mounted like that discussed above. However, a second piece of such a wing design would be capable of moving with respect to the first piece and with respect to opening 34. Thus, the amount of opening 34 accessible by a pet or the like could be varied from a substantially closed position to one which is as wide as the overlap with the first piece of the wing. It is also contemplated to provide an enclosure design which employs only a single wing. In such a design, enclosure 10 would preferably be situated against one side of a window, while the single wing would be utilized to close the space formed between the opposite sides of enclosure 10 and the window. Operation of enclosure 10 in this variation would preferably be in the same fashion as that described above. It is also contemplated to provide a standard sized enclosure 10 with a plurality of differently sized wings 18 and 20. Such differently sized wings 18 and 20 would preferably be of different widths so that a user could choose wings suitable for sealing the cooperation between enclosure 10 and a window. In this regard, it is noted that for different window sizes, differently sized wings may be required. For example, in order to obtain a minimum/maximum front opening 34, wider or narrower wings 18 and 20 may be required depending upon the width of the window. Also, should the user desire a wider or narrower front opening 34, he or she could clearly utilize wider or narrower wings 18 and 20 in a single window. Finally, it is contemplated to provide a hinged door or the like that could be opened or closed to, in turn, allow or restrict access to interior space 32 of housing 12. The latter two designs could allow a user to selectively prevent access to a pet during inclement weather or the like. In addition, such designs could also allow a user to prevent unwanted heat transfer to or from the outside environment.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A pet enclosure for mounting in a window, comprising:
a housing including an interior space, said housing consisting entirely of transparent material;
a horizontal extension attached to said housing and adapted to engage a sill portion of the window; and
a vertical extension attached to said housing and adapted to engage a sash portion of the window.

2. The pet enclosure of claim 1, wherein said horizontal and vertical extensions are formed integrally with said housing.

3. The pet enclosure of claim 1, wherein one of said horizontal extension or said vertical extension further includes a first track.

4. The pet enclosure of claim 3, further comprising at least a first wing slidably engaged with said first track.

5. The pet enclosure of claim 4, wherein the other of said horizontal extension or said vertical extension further includes a second track.

6. The pet enclosure of claim 5, wherein said first wing is slidably engaged with said first and second tracks.

7. The pet enclosure of claim 6, further comprising at least a second wing slidably engaged with said first and second tracks.

8. The pet enclosure of claim 7, wherein each of said first and said second wings includes an aperture, and said vertical extension includes at least two elongated apertures capable of aligning with the apertures of said first and second wings, said elongated apertures being capable of receiving fixation means for mounting to the sash portion of the window.

9. The pet enclosure of claim 8, wherein said horizontal extension includes at least one aperture capable of receiving fixation means for mounting to the sill portion of the window.

10. The pet enclosure of claim 6, wherein access into said interior space of said housing is determined by the position of the first wing.

11. The pet enclosure of claim 1, further comprising at least one accessory disposed in said interior space.

12. The pet enclosure of claim 11, wherein said accessory is selected from the group consisting of hooks, rods, clips, pillows, benches and shelves.

13. The pet enclosure of claim 1, further comprising a litter box disposed in said interior space.

14. A pet enclosure for mounting in a window, comprising:
a housing defining an interior space and having an opening to the interior space;
a horizontal extension attached to said housing, said horizontal extension being capable of engaging a sill portion of the window and including a first track;
a vertical extension attached to said housing, said vertical extension being capable of engaging a sash portion of the window and including a second track; and
at least two wings, each said wing being slidably engaged with said first and second tracks so that sliding movement of said wings defines an accessible size of the opening to said interior space.

15. The pet enclosure of claim 14, wherein said housing is constructed entirely of transparent material.

16. The pet enclosure of claim 15, wherein said horizontal and vertical extensions are formed integrally with said housing.

17. The pet enclosure of claim 14, wherein each said at least two wings includes an aperture, and said vertical extension includes at least two elongated apertures capable of aligning with the apertures in said at least two wings, said aligned apertures being capable of receiving fixation means for mounting to the sash portion of the window.

18. The pet enclosure of claim 17, wherein said horizontal extension includes at least one aperture capable of receiving fixation means for mounting to the sill portion of the window.

19. The pet enclosure of claim 14, further comprising a litter box disposed in said interior space.

20. A pet enclosure for mounting in a window, comprising:
a housing defining an interior space and having an opening to said interior space, said housing being constructed entirely of transparent material;
a horizontal extension attached to said housing, said horizontal extension being capable of engaging a sill portion of the window and including a first track;
a vertical extension attached to said housing, said vertical extension being capable of engaging a sash portion of the window and including a second track; and
at least two wings, each said wing being slidably engaged with said first and second tracks so that sliding movement of said wings defines a size of said opening to said interior space which is accessible.

21. The pet enclosure of claim 20, wherein said horizontal and vertical extensions are formed integrally with said housing.

22. The pet enclosure of claim 20, wherein each of said at least two wings includes an aperture, and said vertical extension includes at least two elongated apertures capable of aligning with the apertures in said at least two wings, said elongated apertures being capable of receiving fixation means for mounting to the sash portion of the window.

23. The pet enclosure of claim 22, wherein said horizontal extension includes at least one aperture capable of receiving fixation means for mounting to the sill portion of the window.

24. The pet enclosure of claim 20, further comprising a litter box disposed in said interior space.
